(19) United States
(12) Patent Application Publication
(10) Pub. No.: US 2010/0269080 A1
(43) Pub. Date: Oct. 21, 2010

(54) COMPUTER-AIDED DESIGN SYSTEM AND METHOD FOR SIMULATING PCB SPECIFICATIONS

(75) Inventors: SHEN-CHUN LI, Tu-Cheng (TW); YUNG-CHIEH CHEN, Tu-Cheng (TW); SHOU-KUO HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/558,682

(22) Filed: Sep. 14, 2009

(30) Foreign Application Priority Data
Apr. 21, 2009 (CN) 200910301702.2

(51) Int. Cl. G06F 17/50

(52) U.S. Cl. 716/6; 716/10; 716/15; 703/14

(57) ABSTRACT

A computer-aided design system and method are provided. The computer-aided design method reads PCB design data from a storage system, obtains a plurality of circuit signals from the PCB design data, and groups the differential signals into a plurality of differential signal pairs. The computer-aided design method further sets a signal design standard for each of the differential signal pairs according to the electrical characteristics of the differential signal pair, and compiles each of the signal design standards into an instruction set. In addition, the computer-aided design method generates a PCB design specification by integrating each of the instruction sets and the PCB design data, and stores the PCB design specification into the storage system.

### BACKGROUND

1. Technical Field

Embodiments of the present disclosure relate generally to computer-aided design systems and methods, and more particularly to a computer-aided design system and method for simulating printed circuit board (PCB) specifications.

2. Description of Related Art

PCBs provide a mechanism for implementing a circuit design (i.e., the interconnection of electrical devices and components) for use, e.g., in a computer system. In designing a PCB, both component placement (layout) and signal path routing must be determined. For simple PCBs, designs may be done manually without too much trouble, while for complex PCB designs, the layout and signal path routing becomes more and more complex and tedious. As is known in the art, computer-aided design (CAD) tools can be used to assist in designing the layout and signal routing for a PCB. A CAD tool typically provides commonly used PCB design-related data comprising at least component placement and signal path routing information. However, such common design-related data may be inaccurate when designing a PCB for unusual or non-standard environments.

Accordingly, there is a need for an improved computer-aided design system and method for simulating PCB specifications, so as to overcome the above-mentioned problems.

### BRIEF DESCRIPTION OF THE DRAWINGS

FIG. 1 is a schematic diagram of one embodiment of a computer-aided design system.

FIG. 2 is a flowchart of one embodiment of a method for simulating PCB specifications by using the computer-aided design system of FIG. 1.

FIG. 3 is a flowchart of detailed descriptions of S23 in FIG. 2.

FIG. 4 is a plane view of one embodiment of a PCB.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

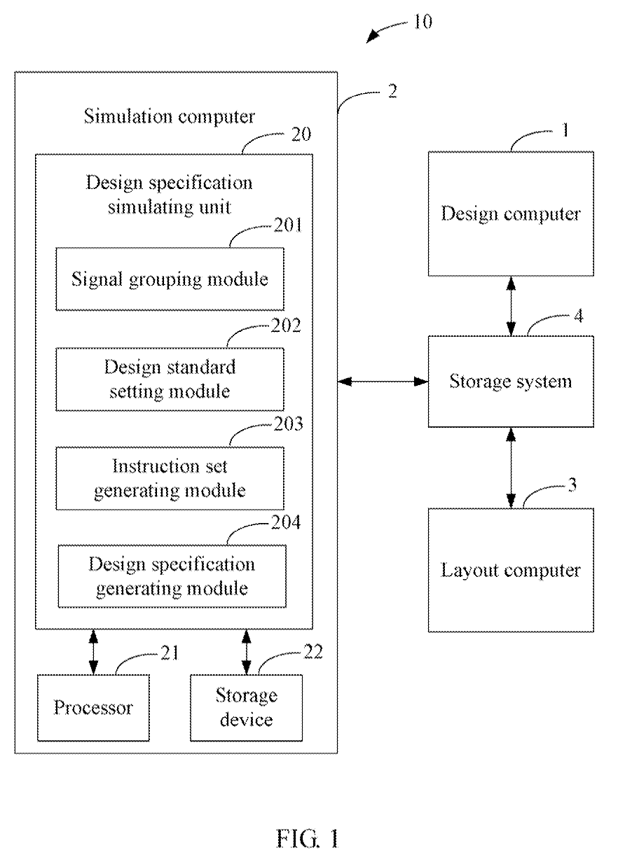

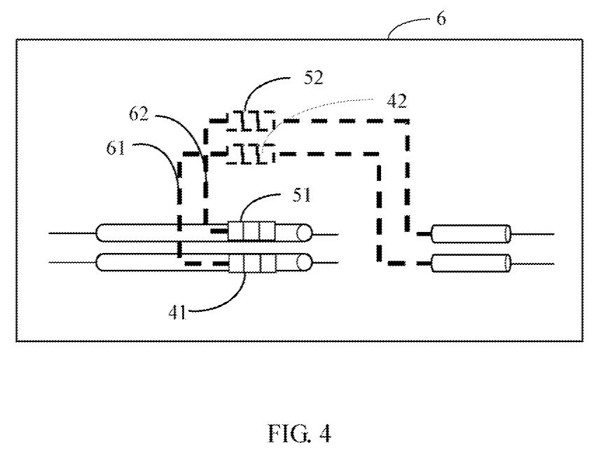

FIG. 1 is a schematic diagram of one embodiment of a computer-aided design system 10. In one embodiment, the computer-aided design system 10 is used to simulate a printed circuit board (PCB) design specification according to PCB design data developed during the process of designing a PCB. The PCB design data may include information of electronic components included in the PCB, and electrical characteristics of a plurality of circuit signals generated by the electronic components and transmitted on the PCB, such as differential signals, for example. The electrical characteristics may be signal transmission delay characteristics, signal relative delay characteristics, or signal trace restriction characteristics. Correspondingly, the PCB design specification may include signal transmission delay standards, signal relative delay standards, and signal trace restriction standards. Depending on the embodiment with respect to FIG. 4, the electrical characteristics of the differential signals are described.

FIG. 4 is a plane view of one embodiment of a PCB 6. The PCB 6 may include two electronic components, such as a first capacitor 41 and a second capacitor 51, that are positioned on a top layer of the PCB 6, and another two electronic elements, such as a first resistor 42 and a second resistor 52, that are positioned on a bottom layer of the PCB 6. The PCB 6 further includes a plurality of trace lines, such as a first trace line 61 and a second trace line 62, that are connected to the electronic components. The first trace line 61 is connected to the first capacitor 41 and the first resistor 42, and the second trace line 62 is connected to the second capacitor 51 and the second resistor 52. The differential signals are generated by the different electronic components of the PCB 6, and transmitted through the different trace lines (e.g., the first trace line 61 and the second trace line 62) on the top layer of the PCB 6. During the process of designing the PCB, the electrical characteristics of the differential signals should be considered. The signal transmission delay characteristics represent characteristics of a differential signal transmitted through a trace line (e.g., the first trace line 61). The signal relative delay characteristics represent characteristics of two differential signals transmitted through two relative trace lines (e.g., the first trace line 61 and the second trace line 62). The signal trace restriction characteristics define characteristics of different trace lines that may include a length of a trace line (e.g., the first trace line 61) and a distance between two trace lines (e.g., the first trace line 61 and the second trace line 62).

Depending on the embodiment with respect FIG. 1, the computer-aided design system 10 includes a design computer 1, a simulation computer 2, a layout computer 3, and a storage system 4. The design computer 1 is operable to generate the PCB design data during the process of designing the PCB, and store the PCB design data in the storage system 4. The simulation computer 2 is operable to read the PCB design data from the storage system 4 when simulating the PCB design specifications, and obtain a plurality of differential signals based on the PCB design data. The simulation computer 2 is further operable to analyze the plurality of differential signals to generate a PCB design specification, and store the PCB design specification in the storage system 4. The layout computer 3 is operable to read the PCB design specifications from the storage system 4, and simulate a PCB according to the PCB design specification. The storage system 4 is operable to store the PCB design data and the PCB design specification. In the embodiment, the storage system 4 may be a hard disk drive, an optical drive, a networked drive, or some combination of various digital storage systems.

The simulation computer 2 may include a design specification simulating unit 20, at least one processor 21, and a storage device 22. In one embodiment, one of more computerized codes of the design specification simulating unit 20 may be included in the storage device 22 or any computer readable medium of the simulation computer 2, and may be executed by the at least one processor 21. In another embodiment, the design specification simulating unit 20 may be included in an operating system of the simulation computer 2, such as the Unix, Linux, Windows 95, 98, NT, 2000, XP, Vista, Mac OS X, an embedded operating system, or any other compatible operating system. In the embodiment, the storage device 22 may be an internal storage device, such as a random access memory (RAM) for temporary storage of information and/or a read only memory (ROM) for permanent storage of information. The storage device 22 may also be an external storage device, such as a hard disk, a storage card, or a data storage medium.

In one embodiment, the design specification simulating unit 20 may include a signal grouping module 201, a design standard setting module 202, an instruction set generating module 203, and a design specification generating module 204. Each of the function modules 201-204 may comprise one or more computerized operations executable by the at least one processor 21 of the simulation computer 2. In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. The modules described herein may be implemented as either software and/or hardware modules and may be stored in any type of computer-readable medium or other storage device.

The signal grouping module 201 is operable to read the PCB design data from the storage system 4, and obtain a plurality of circuit signals from the PCB design data. In one embodiment, the circuit signals may be differential signals that can be transmitted on the PCB, for example. The signal grouping module 201 is further operable to group the differential signals into a plurality of differential signal pairs. Each of the differential signal pairs consists of two differential signals, and defines a relationship between the two differential signals.

The design standard setting module 202 is operable to set a signal design standard for each of the differential signal pairs according to the electrical characteristics of the differential signal pair. In one embodiment, the electrical characteristics may be signal transmission delay characteristics, signal relative delay characteristics, or signal trace restriction characteristics. The signal design standard may be a signal transmission delay standard, a signal relative delay standard, and a signal trace restriction standard of each differential signal pair.

The instruction set generating module 203 is operable to compile each of the signal design standards into an instruction set, and determine whether an instruction set of any differential signal pair needs to be updated. In one embodiment, if any instruction set needs to be updated, the instruction set generating module 203 notifies the design standard setting module 202 to set a new signal design standard for the differential signal pair.

The design specifications generating module 204 is operable to generate a PCB design specification according to each of the instruction sets and the PCB design data, and store the PCB design specification into the storage system 4. After the PCB design specification is generated, the layout computer 3 can simulate a PCB according to the PCB design specification.

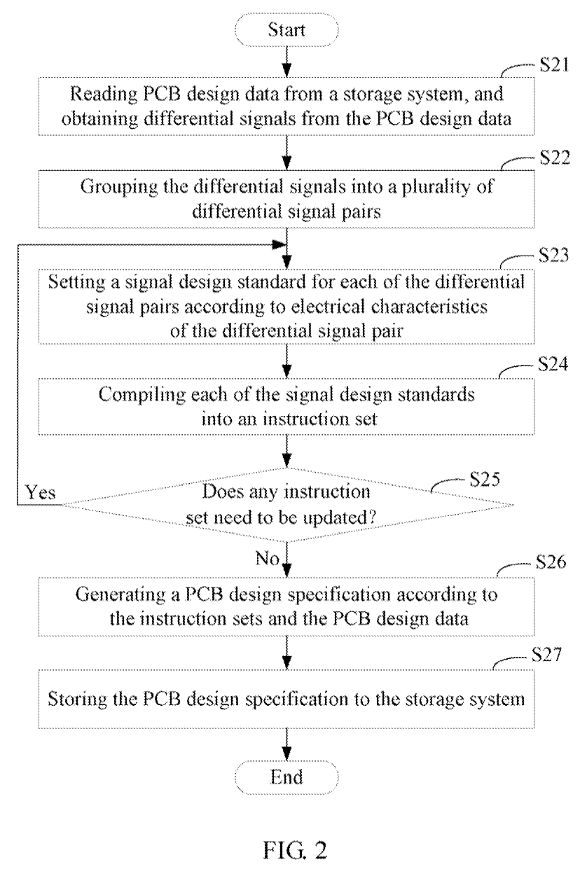

FIG. 2 is a flowchart of one embodiment of a computer-aided design method for simulating PCB specifications by using the design specification simulating unit 20 as described in FIG. 1. Depending on the embodiment, additional blocks may be added, others removed, and the ordering of the blocks may be changed.

In block S21, the signal grouping module 201 reads PCB design data from the storage system 4, and obtain a plurality of circuit signals from the PCB design data. In one embodiment, the PCB design data may include information of electronic components included in a PCB, and electrical characteristics of a plurality of circuit signals transmitted on the PCB, such as differential signals, for example. As mentioned in FIG. 4, the electrical characteristics may be signal transmission delay characteristics, signal relative delay characteristics, or signal trace restriction characteristics.

In block S22, the signal grouping module 201 groups the differential signals into a plurality of differential signal pairs. Each of the differential signal pairs consists of two differential signals, and defines a relationship between the two differential signals.

In block S23, the design standard setting module 202 sets a signal design standard for each of the differential signal pairs according to the electrical characteristics of the differential signal pair. In one embodiment, the signal design standard may be a signal transmission delay standard, a signal relative delay standard, or a signal trace restriction standard of each differential signal pair.

In block S24, the instruction set generating module 203 compiles each of the signal design standards into an instruction set. In block S25, the instruction set generating module 203 determines whether an instruction set needs to be updated. If any instruction set needs to be updated, the procedure returns to block S23 for setting a new signal design standard for the differential signal pair.

Otherwise, if no instruction set needs to be updated, in block S26, the design specification generating module 204 generates a PCB design specification according to each of the instruction sets and the PCB design data. In block S27, the design specification generating module 204 stores the PCB design specification into the storage system 4. After the PCB design specification is generated, the layout computer 3 can simulate a PCB according to the PCB design specification.

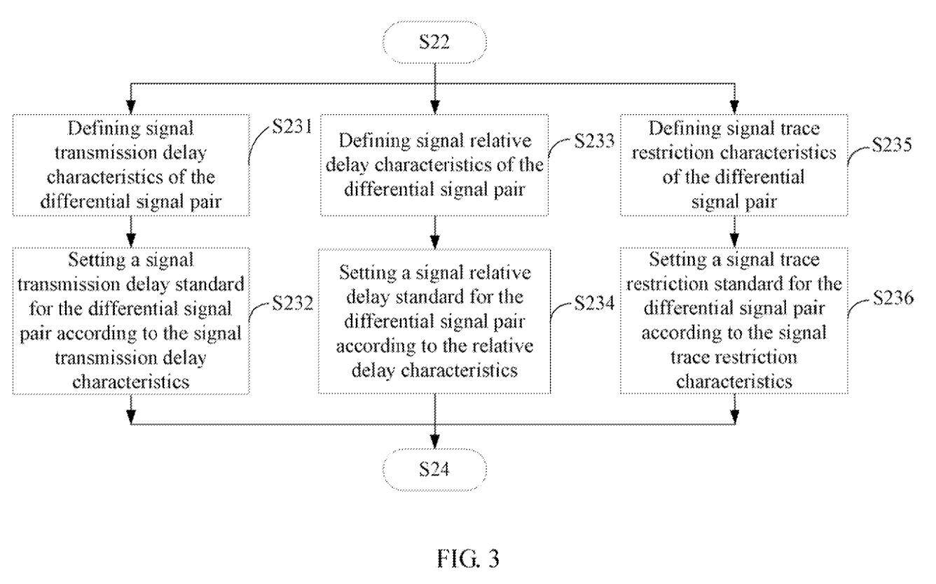

FIG. 3 is a flowchart of detailed descriptions of S23 in FIG. 2. Depending on the embodiment, additional blocks may be added, others removed, and the ordering of the blocks may be changed.

In block S231, the design standard setting module 202 defines signal transmission delay characteristics for each of the differential signal pairs. In block S232, the design standard setting module 202 generates a signal transmission delay standard for each of the differential signal pairs according to the signal transmission delay characteristics of the differential signal pair.

In block S233, the design standard setting module 202 defines signal relative delay characteristics for each of the differential signal pairs. In block S234, the design standard setting module 202 generates a signal relative delay standard according to the signal relative delay characteristics of the differential signal pair.

In block S235, the design standard setting module 202 defines signal trace restriction characteristics for each of the differential signal pairs. In block S236, the design standard setting module 202 generates a signal trace restriction standard according to the signal trace restriction characteristics of the differential signal pair.

All of the processes described above may be embodied in, and fully automated via, functional code modules executed by one or more general purpose processors of computer devices. The functional code modules may be stored in any type of readable medium or other storage devices. Some or all of the methods may alternatively be embodied in specialized the computer devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-aided design system for simulating printed circuit board (PCB) design specifications for a PCB, the computer-aided design system comprising:
a storage system operable to store PCB design data for the PCB; and
a design specification simulating unit comprising:
a signal grouping module operable to read the PCB design data from the storage system, obtain a plurality of differential signals from the PCB design data, and group the differential signals into differential signal pairs;
a design standard setting module operable to set a signal design standard for each of the differential signal pairs according to electrical characteristics of the differential signal pair;
an instruction set generating module operable to compile each of the signal design standards into an instruction set; and
a design specification generating module operable to generate a PCB design specification according to each of the instruction sets and the PCB design data, and store the PCB design specification into the storage system.

2. The computer-aided design system according to claim 1, wherein the instruction set generating module is further operable to determine whether any instruction set needs to be updated, and notify the design standard setting module to set a new signal design standard for a differential signal pair when an instruction set of the differential signal pair needs to be updated.

3. The computer-aided design system according to claim 1, wherein the PCB design data comprise information of electronic components of the PCB, and the electrical characteristics of the differential signals transmitted on the PCB.

4. The computer-aided design system according to claim 1, wherein the electrical characteristics comprise signal transmission delay characteristics, signal relative delay characteristics, and signal trace restriction characteristics.

5. The computer-aided design system according to claim 4, wherein the PCB design specification comprises signal transmission delay standards, signal relative delay standards, and signal trace restriction standards.

6. A computer-aided design method for simulating printed circuit board (PCB) design specifications for a PCB, the computer-aided design method comprising:
(a) reading PCB design data from a storage system, and obtaining a plurality of differential signals from the PCB design data;
(b) grouping the differential signals into a plurality of differential signal pairs;
(c) setting a signal design standard for each of the differential signal pairs according to electrical characteristics of the differential signal pair;
(d) compiling each of the signal design standards into an instruction set;
(e) generating a PCB design specification according to each of the instruction sets and the PCB design data; and
(f) storing the PCB design specification into the storage system.

7. The computer-aided design method according to claim 6, further comprising:
determining whether any instruction set needs to be updated; and
returning block (c) to set a new signal design standard for a differential signal pair if an instruction set of the differential signal pair needs to be updated; or
going to block (d) to generate the PCB design specification if no instruction set of the differential signal pair needs to be updated.

8. The computer-aided design method according to claim 6, wherein the PCB design data comprise information of electronic components of the PCB, and the electrical characteristics of the differential signals transmitted on the PCB.

9. The computer-aided design method according to claim 6, wherein the electrical characteristics comprise signal transmission delay characteristics, signal relative delay characteristics, and signal trace restriction characteristics.

10. The computer-aided design method according to claim 9, wherein the PCB design specification comprises signal transmission delay standards, signal relative delay standards, and signal trace restriction standards.

11. The computer-aided design method according to claim 10, wherein block (c) comprises:
defining the signal transmission delay characteristics for each of the differential signal pairs, and generating a signal transmission delay standard for each of the differential signal pairs according to the signal transmission delay characteristics of the differential signal pair;
defining the signal relative delay characteristics for each of the differential signal pairs, and generating a signal relative delay standard according to the signal relative delay characteristics of the differential signal pair; and
defining the signal trace restriction characteristics for each of the differential signal pairs, and generating a signal trace restriction standard according to the signal trace restriction characteristics of the differential signal pair.

12. The computer-aided design method according to claim 6, wherein each of the differential signal pairs consists of two differential signals, and defines a relationship between the two differential signals.

13. A readable medium having stored thereon instructions that, when executed by at least one processor of a computer device, cause the computer to perform a computer-aided design method for simulating printed circuit board (PCB) design specifications for a PCB, the computer-aided design method comprising:
(a) reading PCB design data from a storage system, and obtaining a plurality of circuit signals from the PCB design data;
(b) grouping the differential signals into a plurality of differential signal pairs;
(c) setting a signal design standard for each of the differential signal pairs according to electrical characteristics of the differential signal pair;
(d) compiling each of the signal design standards into an instruction set;
(e) generating a PCB design specification according to each of the instruction sets and the PCB design data; and
(f) storing the PCB design specification into the storage system.

14. The medium according to claim 13, wherein the method further comprises:
determining whether any instruction set needs to be updated; and
returning block (c) to set a new signal design standard for a differential signal pair if an instruction set of the differential signal pair needs to be updated; or
going to block (d) to generate the PCB design specification if no instruction set of the differential signal pair needs to be updated.

15. The medium according to claim 13, wherein the PCB design data comprise information of electronic components of the PCB, and the electrical characteristics of the differential signals transmitted on the PCB.

16. The medium according to claim 13, wherein the electrical characteristics comprise signal transmission delay characteristics, signal relative delay characteristics, and signal trace restriction characteristics.

17. The medium according to claim 16, wherein the PCB design specification comprises signal transmission delay standards, signal relative delay standards, and signal trace restriction standards.

18. The medium according to claim 17, wherein block (c) comprises:
defining the signal transmission delay characteristics for each of the differential signal pairs, and generating a signal transmission delay standard for each of the differential signal pairs according to the signal transmission delay characteristics of the differential signal pair;
defining the signal relative delay characteristics for each of the differential signal pairs, and generating a signal relative delay standard according to the signal relative delay characteristics of the differential signal pair; and
defining the signal trace restriction characteristics for each of the differential signal pairs, and generating a signal trace restriction standard according to the signal trace restriction characteristics of the differential signal pair.

19. The medium according to claim 13, wherein each of the differential signal pairs consists of two differential signals, and defines a relationship between the two differential signals.
